(19) United States
(12) Patent Application Publication
(10) Pub. No.: US 2014/0072018 A1
(43) Pub. Date: Mar. 13, 2014

(54) LED LAMP COMBINED WITH WIRELESS COMMUNICATION

(71) Applicant: Tai-Chiang GOU, New Taipei (TW)

(72) Inventor: Tai-Chiang GOU, New Taipei (TW)

(21) Appl. No.: 13/611,714

(22) Filed: Sep. 12, 2012

(51) Int. Cl. H04B 3/54; H04B 1/38

(52) U.S. Cl. 375/219

(57) ABSTRACT

An LED lamp combined with wireless communication includes a lamp housing with an electrode contact mounted at one end thereof for connecting a power supply network, a light-emitting diode module mounted at the other end thereof and a driving circuit disposed therein to connect the electrode contact and the light-emitting diode module, a data processing module disposed in the lamp housing and connected to the driving circuit for converting electric signals from the power supply network into data packets, and a data transceiver module disposed in the lamp housing and connected to the data processing module for sending the data packets out via a wireless interface for a terminal device. The data transceiver module can receive data packets from the terminal device via the wireless interface and then the data processing module further converts the data packets into electric signals for transmitting in the power supply network.

### BACKGROUND OF THE INVENTION

1. Field of the Invention

The present invention generally relates to an LED (Light Emitting Diode) lamp, in particular, refers to an LED lamp combined with wireless communication.

2. The Related Art

With the rise of mobile terminal devices, such as mobile phone, tablet PC and notebook computer, the needs for constructing a wireless communication network in the home or work environment is getting more important.

It will take the construction of LAN (Local Area Network) as an example following up. In order to allow every terminal to device that is located at different locations around the environment to connect to the LAN, the most common solution is setting a wireless network system with a wireless AP (Access Point) or setting a power line network system. However, the wireless AP uses radio waves as a data transmission medium, so the communication signals are apt to be obscured when the wireless AP is fitted to the weak signal location. Therefore, in order to transmit-receive the communication signal better, it is very often obliged to use an RJ-45 Ethernet cable to connect and relocate the wireless AP to a less-sheltered location. But it is likely to cause inconvenience to the user.

For example, referring to FIG. 4, a two-story building with four rooms designated as a first room 91, a second room 92, a third room 93 and a fourth room 94 respectively, needs to set up a wireless LAN. In detail, a wireless AP 90 is placed in the first room 91 to transmit-receive Wi-Fi signals for connecting with terminal devices. However, because the Wi-Fi signals sent by the wireless AP 90 are easily blocked by a wall or a floor of the building, the Wi-Fi signals can only be received by the terminal devices in the first room 91. If all of the terminal devices in the first to fourth room 91-94 want to receive the Wi-Fi signals, an RJ-45 Ethernet cable and/or additional wireless AP 90 will need to be set in each room that would be very inconvenient.

The solution of setting the power line network system is realized by using the power supply network to transmit data. In use, one PLC (Power Line Communication) modem is firstly used to convert data packets into electric signals and transmit the electric signals via the power supply network, and then another PLC modem is further used to convert the electric signals back into the data packets again from any power outlet through connecting the PLC modem with the power outlet. Therefore, the using of the power line network system is still limited by the location of the power outlets. Moreover, it needs to use an additional power outlet to plug the PLC modem for using the power line network system, so that will reduce the number of power outlets that user can actually uses.

In view of these disadvantages above, the present solutions for setting up the wireless communication network need to be improved.

### SUMMARY OF THE INVENTION

An objective of this invention is to provide an LED lamp combined with wireless communication. The LED lamp is adapted for being connected to a power supply network and includes a lamp housing with an electrode contact mounted at one end thereof for connecting the power supply network, a light-emitting diode module mounted at the other end thereof and a driving circuit disposed therein to electrically connect the electrode contact and the light-emitting diode module so as to adjust the voltage from the power supply network and then provide appropriate working voltage for the light-emitting diode module, a data processing module disposed in the lamp housing and connected to the driving circuit, and a data transceiver module disposed in the lamp housing and connected to the data processing module.

In use, the data processing module is capable of converting electric signals from the power supply network into data packets and then the data transceiver module sends the data packets out via a wireless interface for an external terminal device. On the contrary, the data transceiver module is capable of receiving data packets from the terminal device via the wireless interface and then the data processing module further converts the data packets into electric signals for transmitting in the power supply network.

As described above, the LED lamp combined with wireless communication in this invention can make signals converted between the electric signals and the data packets by the data processing module, and can further transmit-receive the data packets for/from the external terminal device by the data transceiver module. Therefore, the LED lamp has the function of a repeater or a wireless AP, and is very convenient to construct a wireless communication network.

### BRIEF DESCRIPTION OF THE DRAWINGS

The present invention will be apparent to those skilled in the art by reading the following description, with reference to the attached drawings, in which:

FIG. 1 shows an exploded view of an LED lamp combined with wireless communication according to an embodiment of the present invention;

FIG. 2 is a functional block diagram of the LED lamp of FIG. 1;

FIG. 3 shows a use state of the LED lamp of FIG. 1, wherein a wireless communication network is constructed by the LED lamps; and

FIG. 4 shows a conventional solution of constructing a wireless communication network.

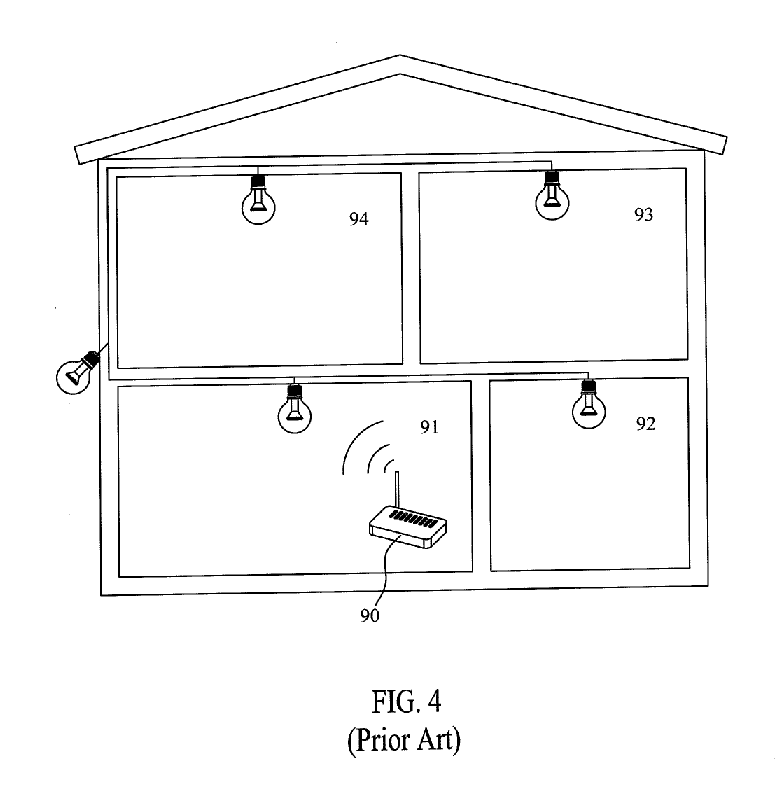

### DETAILED DESCRIPTION OF THE PREFERRED EMBODIMENT

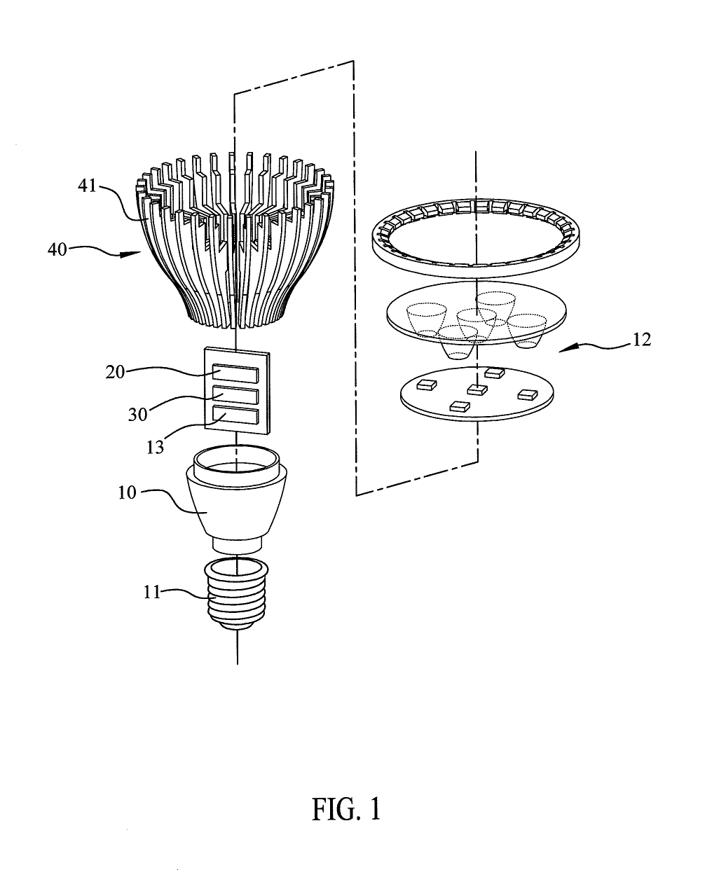

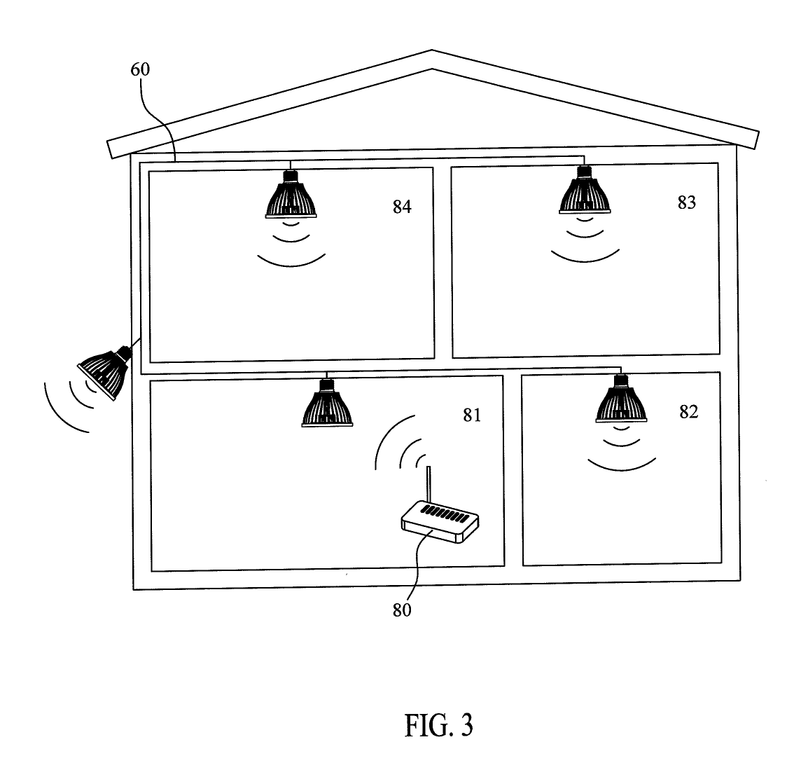

Referring to FIG. 1 and FIG. 3, an LED lamp combined with wireless communication according to an embodiment in this invention is described below and adapted for being connected to a power supply network 60. The LED lamp combined with wireless communication includes a lamp housing 10 with an electrode contact 11 mounted at one end thereof for connecting the power supply network 60, a light-emitting diode module 12 mounted at the other end thereof and a driving circuit 13 disposed therein, a data transceiver module 20, a data processing module 30, and a cooling element 40.

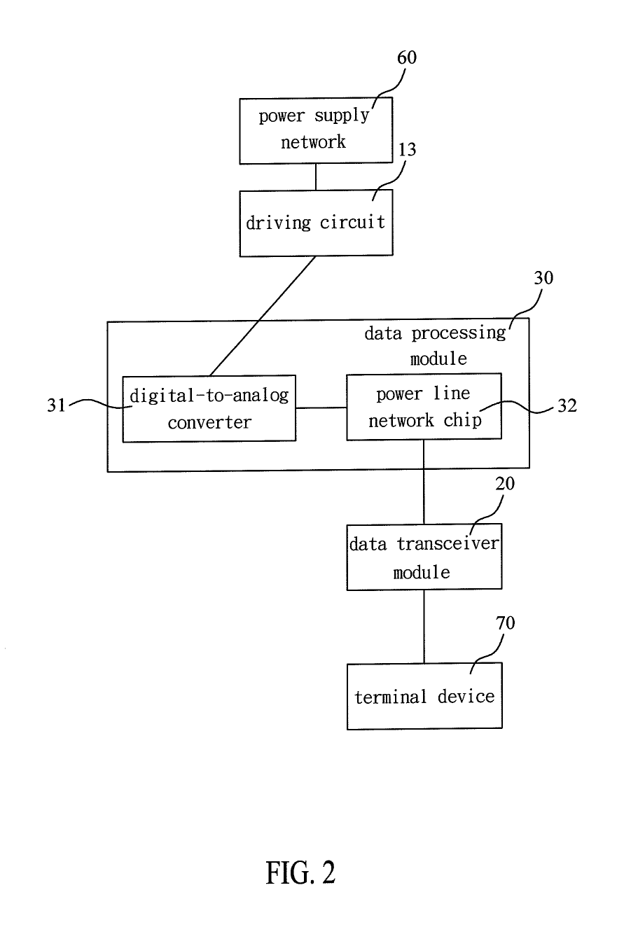

Referring to FIG. 1, FIG. 2 and FIG. 3, the driving circuit 13 is electrically connected with the electrode contact 11 and the light-emitting diode module 12 to adjust the voltage from the power supply network 60 and then provide appropriate working voltage for the light-emitting diode module 12. The cooling element 40 includes a plurality of cooling fins 41 arranged around the lamp housing 10 and the light-emitting diode module 12. Each cooling fin 41 is disposed substantially along the generatrix of the lamp housing 10. The outer diameter of the cooling element 40 gradually increases from one end of the lamp housing 10 equipped with the electrode contact 11 to the light-emitting diode module 12. The light-emitting diode module 12 includes at least one light-emitting diode, a light guider and a lamp shade formed in a proper shape based on the use, but these are not the creative features of the present invention, so it will not be described here.

The data transceiver module 20 and the data processing module 30 are placed inside the lamp housing 10, wherein the data processing module 30 is connected with the driving circuit 13 and the data transceiver module 20 is connected with the data processing module 30. In this embodiment, the data transceiver module 20 and the data processing module 30 are co-located on a single circuit board with the driving circuit 13. But in other feasible embodiments, the data transceiver module 20 and the data processing module 30 may be placed on two separated circuit boards, and then connected to the driving circuit 13. The data processing module 30 is capable to convert electric signals from the power supply network 60 into data packets and then the data transceiver module 20 sends the data packets out via a wireless interface (for example, a wireless LAN) for an external terminal device 70. Moreover, the data transceiver module 20 is capable of receiving data packets from the terminal device 70 via the wireless interface and then the data processing module 30 further converts the data packets into electric signals for transmitting in the power supply network 60.

Referring to FIG. 2, the data processing module 30 in this embodiment is a network adapter for converting analog electric signals transmitted in the power supply network 60 into data packets, or re-converting data packets into analog electric signals.

In detail, the data processing module 30 includes a digital-to-analog converter 31 electronically connected to the driving circuit 13 for digitalizing the electric signals from the power supply network 60, and a power line network chip 32 connected with the digital-to-analog converter 31 for converting the digitalized electric signals into the data packets. The data transceiver module 20 is further connected with the power line network chip 32 for receiving the data packets. On the contrary, when the data packets from the terminal device 70 are received by the data transceiver module 20 and further transmitted to the data processing module 30, the power line network chip 32 converts the data packets into digital signals and then the digital-to-analog converter 31 further converts the digital signals into electric signals for transmitting in the power supply network 60.

Referring to FIG. 1 and FIG. 3, in this embodiment, the data transceiver module 20 is further electrically connected with the cooling element 40 to make the cooling fins 41 be acted as an antenna for forming the wireless interface.

Referring to FIG. 3, a building having a plurality of rooms uses the LED lamp combined with wireless communication of the present invention as the lighting source in each room as well as the outdoor lighting. In this embodiment, there are four rooms designated as a first room 81, a second room 82, a third room 83 and a fourth room 84 respectively. In use, a wireless AP 80 is located in the first room 81 for sending and receiving Wi-Fi signals. The Wi-Fi signals are firstly received and converted into electric signals by the LED lamp located in the first room 81, and then the electric signals are transmitted to other LED lamps located in the second, third, fourth rooms 82-84 and the outdoor wall through the power supply network 60 constructed in the building. After each of the data processing modules 30 (shown in FIG. 2) mounted in the LED lamps receive the electric signals sent through the power supply network 60, the electric signals will be re-converted into data packets and then re-sent as Wi-Fi signals to the terminal devices 70 by the data transceiver modules 20 (shown in FIG. 2).

Therefore, the LED lamp combined with wireless communication in this invention is capable to transmit communication signals right after being installed in any existing lamp holder, and the communication signals are capable to detour the walls and the floors of the building without using any RJ-45 network cable. Furthermore, the lamp holders are generally set at the roof of the room which is not sheltered by any object, so the signal sent from the LED lamp will not be obscured.

In the embodiment above, the wireless LAN is used to transmit Wi-Fi signals as the wireless interface. But the LED lamp combined with wireless communication in this invention should not be limited by setting the wireless LAN or transmitting the Wi-Fi signals. In other feasible embodiment, the wireless interface may be an infrared ray transmission or any kind of radio wave according to the actual use.

As described above, the LED lamp combined with wireless communication in this invention can make signals converted between the electric signals and the data packets by the data processing module 30, and can further transmit-receive the data packets for/from the external terminal device 70 by the data transceiver module 20. Therefore, the LED lamp has the function of a repeater or a wireless AP, and is very convenient to construct a wireless communication network.

What is claimed is:

1. An LED lamp combined with wireless communication, connected to a power supply network (60), comprising:
a lamp housing (10) with an electrode contact (11) mounted at one end thereof for connecting the power supply network, a light-emitting diode module (12) mounted at the other end thereof and a driving circuit (13) disposed therein, the driving circuit electrically connecting the electrode contact and the light-emitting diode module to adjust the voltage from the power supply network and then provide appropriate working voltage for the light-emitting diode module;
a data processing module (30) disposed in the lamp housing and connected to the driving circuit; and
a data transceiver module (20) disposed in the lamp housing and connected to the data processing module,
wherein the data processing module is capable of converting electric signals from the power supply network into data packets and then the data transceiver module sends the data packets out via a wireless interface for an external terminal device (70), moreover, the data transceiver module is capable of receiving data packets from the terminal device via the wireless interface and then the data processing module further converts the data packets into electric signals for transmitting in the power supply network.

2. The LED lamp as claimed in claim 1, wherein the data processing module includes a digital-to-analog converter (31) electronically connected to the driving circuit for digitalizing the electric signals from the power supply network and a power line network chip (32) connected with the digital-to-analog converter for converting the digitalized electric signals into the data packets, the data transceiver module is connected with the power line network chip for receiving the data packets, on the contrary, when the data packets from the terminal device are received by the data transceiver module and further transmitted to the data processing module, the power line network chip converts the data packets into digital signals and then the digital-to-analog converter further converts the digital signals into electric signals for transmitting in the power supply network.

3. The LED lamp as claimed in claim 1, wherein the wireless interface is a wireless LAN.

4. The LED lamp as claimed in claim 1, wherein the wireless interface is an infrared ray transmission.

5. The LED lamp as claimed in claim 1, wherein the wireless interface is radio waves.

6. The LED lamp as claimed in claim 1, further comprising a cooling element (40) which includes a plurality of cooling fins (41) arranged at regular intervals around the lamp housing and the light-emitting diode module, each cooling fin is disposed substantially along the generatrix of the lamp housing, the outer diameter of the cooling element gradually increases from one end of the lamp housing equipped with the electrode contact to the light-emitting diode module.

7. The LED lamp as claimed in claim 6, wherein the data transceiver module is further electrically connected with the cooling element to make the cooling fins be acted as an antenna for forming the wireless interface.
